(19) United States
(12) Patent Application Publication
(10) Pub. No.: US 2005/0086545 A1
(43) Pub. Date: Apr. 21, 2005

(54) Information handling system including fast acting current monitoring and throttling capability

(75) Inventors: John J. Breen, Harker Heights, TX (US); Guangyong Zhu, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/688,546

(22) Filed: Oct. 17, 2003

(51) Int. Cl. G06F 1/26

(52) U.S. Cl. 713/300

(57) ABSTRACT

An information handling system (IHS) is provided which can be powered by an AC adapter or a battery. The AC adapter output current and the battery output current are continuously monitored. If the AC adapter output current exceeds a predetermined threshold current even for an instant the IHS reduces the frequency at which the IHS's processor operates to reduce current drain on the adapter. If the battery output current exceeds a predetermined threshold current even for an instant, the IHS reduces processor frequency to reduce current drain on the battery. The predetermined threshold current level can be dynamic depending on the power output rating of the particular adapter and the power output rating of the particular battery.

### BACKGROUND

The disclosures herein relate generally to information handling systems (IHS's) and more particularly to protecting battery-powered portable IHS's from excess current conditions.

As the value and use of information continue to increase, individuals and businesses seek additional ways to process and store information. One option available to users is information handling systems. An information handling system (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable battery-powered IHS's continue to progress with ever increasing information handling capabilities. However, concurrent with this performance increase, the amount of power which portable IHS's draw from their power supply systems continues to increase as well. This means that the AC to DC power adapters and batteries which supply power to portable IHS's are pressed for more and more current when operating under peak loads. This problem is exacerbated when processors intended for use in fixed desktop machines are used in portable IHS's for cost reasons. Under these conditions, it is possible that the power adapter and battery will run hotter than desired. If this occurs, the battery and adaptor could latch-off resulting in data loss and poor customer experience.

One solution to this problem is to simply use a larger power adapter and a larger battery. While solving the problem, this approach significantly increases the overall cost of the portable IHS. Also this approach increases the weight of the portable IHS and this is of course very undesirable in a portable device.

Present day processors include a bidirectional “processor hot” pin or PROCHOT# pin which when asserted indicates either that the processor is operating at a reduced frequency or that the processor is being commanded to reduce its frequency of operation. Today's IHS's employ this pin to protect the IHS from excessive current draw from the AC/DC adapter and/or battery. When the IHS's Basic Input Output System (BIOS) software senses an over-current condition, it asserts the appropriate signal at the PROCHOT# pin to reduce the frequency of operation of the processor. The amount of current drain and load on the adapter and/or battery is thus reduced. The BIOS software senses the adapter current through a general purpose I/O or GPIO connection. The BIOS software senses battery current from a system management bus (SMBUS) which controls battery charging and power distribution in the IHS. By observing the adapter current and battery current, the BIOS software makes a determination of when the PROCHOT# signal should be asserted to reduce the operating frequency of the processor. Unfortunately, the BIOS software monitors the adapter and battery current non-continuously, namely at a relatively low rate, for example 10-20 times per second. If the power adapter current or battery current exhibits rapid changes or pulses, it is possible that the relatively slow acting BIOS software may not detect these rapid changes and pulses. Should this occur, the adapter and battery may be driven beyond their intended capabilities and thus experience excessive current draw and heating. This may result in battery and/or AC-DC latch-off and data loss.

What is needed is a way to detect rapid changes and pulses in AC/DC adapter current and battery current to enable fast throttling when over-current conditions are detected.

### SUMMARY

Accordingly, in one embodiment, a method is disclosed for operating an information handling system (IHS) including a processor. The method includes determining if a power adapter or a battery is supplying power to the IHS. The method also includes continuously monitoring the output current of the power adapter if the power adapter is supplying power to the IHS. The method further includes continuously monitoring the output current of the battery if the battery is supplying power to the IHS. The method still further includes reducing the frequency at which the processor operates if the power output of the power adapter exceeds a first threshold current level and reducing the frequency at which the processor operates if the power output of the battery exceeds a second threshold current level.

In another embodiment, an information handling system (IHS) is disclosed which includes a processor and a memory coupled to the processor. The IHS also includes an AC adapter and a battery for supplying power to the IHS. The IHS further includes a power control circuit which is coupled to the AC adapter and the battery. The power control circuit reduces the frequency at which the processor operates if the power output of either the AC adapter or the battery instantaneously exceeds a predetermined threshold level. The predetermined threshold level is dependent on the power output rating of the AC adapter and the power rating of the battery which are sensed by the power controller circuit.

principal advantage of the embodiments disclosed herein is that rapid changes in adapter and battery current of an IHS are quickly detected to enable IHS throttling to reduce current draw on the adapter and battery.

### BRIEF DESCRIPTION OF THE DRAWINGS

FIG. 1 is a block diagram of the disclosed information handling system.

FIG. 2 is a block diagram of another embodiment of the disclosed information handling system.

FIG. 3 is a block diagram of yet another embodiment of the disclosed information handling system.

FIG. 4 is a flowchart depicting process flow in one embodiment of the disclosed information handling system.

### DETAILED DESCRIPTION

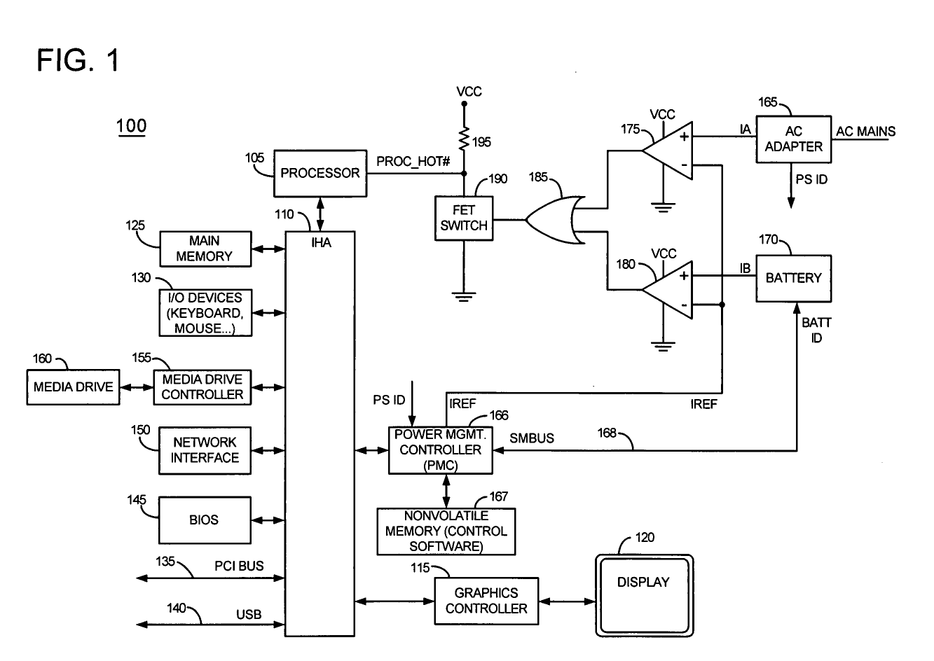

FIG. 1 is a block diagram of the disclosed information handling system (IHS) 100. For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In one embodiment, IHS 100 is a portable system such as a notebook, laptop, PDA or other portable, battery-powered system. IHS 100 includes a processor 105 such as an Intel Pentium series processor or one of many other processors currently available. An Intel Hub Architecture (IHA) chipset 110 provides IHS 100 with glue-logic that connects processor 105 to other components of IHS 100. Chipset 110 carries out graphics/memory controller hub functions and I/O functions. More specifically, chipset 110 acts as a host controller which communicates with a graphics controller 115 coupled thereto. Graphics controller 115 is coupled to a display 120. Chipset 110 also acts as a controller for main memory 125 which is coupled thereto. Chipset 110 further acts as an I/O controller hub (ICH) which performs I/O functions. Input devices 130 such as a mouse, keyboard, and tablet, are also coupled to chipset 110 at the option of the user. An expansion bus 135, such as a Peripheral Component Interconnect (PCI) bus, PCI Express bus, SATA bus or other bus is coupled to chipset 110 as shown to enable IHS 100 to be connected to other devices which provide IHS 100 with additional functionality. A universal serial bus (USB) 140 or other I/O bus is coupled to chipset 110 to facilitate the connection of peripheral devices to IHS 100. System basic input-output system (BIOS) 145 is coupled to chipset 110 as shown. BIOS software 145 is stored in nonvolatile memory such as CMOS or FLASH memory. A network interface controller (NIC) 150 is coupled to chipset 110 to facilitate connection of system 100 to other information handling systems. A media drive controller 155 is coupled to chipset 110 so that devices such as media drive 160 can be connected to chipset 110 and processor 105. Devices that can be coupled to media drive controller 155 include CD-ROM drives, DVD drives, hard disk drives and other fixed or removable media drives. IHS 100 includes an operating system which is stored on media drive 160. Typical operating systems which can be stored on media drive 160 include Microsoft Windows XP, Microsoft Windows 2000 and the Linux operating systems. (Microsoft and Windows are trademarks of Microsoft Corporation.)

IHS 100 includes a power management controller (PMC) 166 which is coupled to chipset 100 as shown. PMC 166 controls power supply functions within IHS 100 under the direction of control software stored in nonvolatile FLASH memory 167. One output of PMC 166 is a system management bus (SMBUS) 168.

Processor 105 includes a PROC_HOT or “processor hot” terminal. When a PROC_HOT# signal is asserted on the PROC_HOT terminal, processor 105 reduces the frequency at which it operates. IHS 100 includes an AC/DC power adapter 165 which is coupled to a source of AC mains power (not shown). AC/DC adapter converts AC mains voltage into DC voltage which is used by the circuits of IHS 100. IHS 100 also includes a battery 170 which supplies DC voltage to IHS 100 when AC adapter power is not available.

AC adapter 165 includes an IA current output at which an IA current signal indicates the amount of adapter current presently being drawn from AC/DC power adapter 165 by IHS 100. The IA output of adapter 165 is coupled to the non-inverting input (+) of comparator 175. The inverting input (−) of comparator 175 is coupled to a reference current output, IREF, from PMC 166. If the adapter current, IA, exceeds the predetermined reference current, IREF, then the output of comparator 175 goes high.

Battery 170 includes an IB current output at which an IB current signal indicates the amount of battery current presently being drawn from battery 170 by IHS 100. The IB output of battery 170 is coupled to the non-inverting (+) input of a comparator 180. The inverting input (−) of comparator 180 is coupled to reference current output, IREF, of PMC 166. If the battery current, IB, exceeds the predetermined reference current signal, IREF, then the output of comparator 180 goes high.

The outputs of comparators 175 and 180 are coupled to respective inputs of a two input OR gate 185. The output of OR gate 185 is coupled to the input of an FET switch 190 as shown. The output of FET switch 190 is coupled via a pull up resistor 195 to DC voltage source VCC. The output of FET switch 190 is also coupled to the processor hot (PROC_HOT#) terminal of processor 105.

It is thus seen that whenever either the adapter current, IA, or the battery current, IB, exceeds a predetermined threshold level set by a reference current signal IREF, that the output of OR gate 185 will be driven high. This turns on FET switch 190 which drives the output of FET switch 190 low. Thus the PROC_HOT# is driven low which causes processor 105 to throttle down its operating frequency to reduce power consumption by IHS 100. The hardware circuits described above are capable of responding to rapid fluctuations and pulses in the adapter current, IA, and battery current, IB, much faster than the software BIOS method described earlier. Moreover, IHS 100 is capable of responding to such current fluctuations and pulses in real time.

The reference current IREF, also called a reference current threshold, is set by power management controller (PMC) 166 under the direction of control software in memory 167. PMC 166 makes a decision as to the particular IREF current reference to employ depending on the power ratings of the particular AC adapter 165 and battery 170 plugged into the IHS. The higher the power ratings of AC adapter 165 and battery 170, the higher IREF can be. AC adapter 165 includes a PS ID output which is coupled to the PS ID input of PMT 166. The PS ID of an adapter is a unique code that provides information regarding the particular adapter, for examples its power rating. This power rating information is conveyed to PMC 166 when the particular adapter 165 is plugged into IHS 100. For example, a PS ID of 001 may indicate a 75 watt adapter, a PS ID of 010 may indicate a 90 watt adapter, a PS ID of 011 may indicate a 110 watt adapter and a PS ID of 111 may indicate a 150 watt adapter. Whatever power adapter 165 is plugged into IHS 100, PMC 166 receives that adapter's unique PS ID code so that PMC knows the power rating of the adapter.

Another factor that PMC 166 uses to set the reference current IREF is the power rating of battery 170. Each battery 170 includes a battery ID code, BATT ID, which indicates the power rating of the battery. Various battery ID codes may indicate battery power ratings such as 75 watt hours, 90 watt hours, 110 watt hours and 150 watt hours, for example. Battery 170 includes a BATT ID output which is coupled to SMBUS 168 so that battery power rating information is transmitted to PMC 166 for use in determining IREF for particular battery and power adapter combinations. An appropriate current reference threshold for each combination of adapter power rating and battery power rating is conveniently stored in a look-up table in nonvolatile memory 167 for easy access by control software and PMC 166. In this manner an appropriate reference current IREF is dynamically selected depending on the particular combination of AC adapter 165 and battery 170.

From the above, it will be appreciated that the adapter output current, IA, and the battery output current, IB, are continuously monitored in real time by fast acting hardware, namely the power control circuit formed by PMC 166, comparators 175 and 180, OR gate 185 and FET switch 190. If the reference current threshold IREF is exceeded even for an instant by adapter output current, IA, or battery output current, IB, then FET switch 190 closes, thus asserting the PROC_HOT# signal to reduce the operating frequency of processor 105. In other words, the power control circuitry in IHS 100 is sufficiently fast to instantaneously respond in real time to pulses and fluctuations in the AC adapter and battery output signals which exceed the IREF threshold.

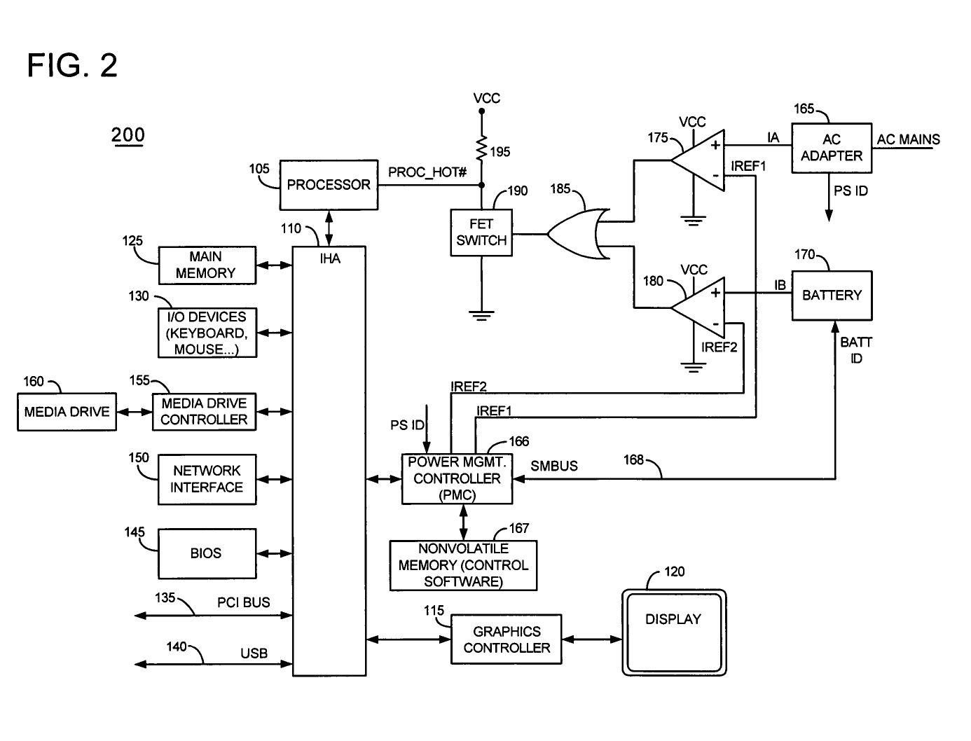

FIG. 2 shows a block diagram of another embodiment of the information handling system as IHS 200. IHS 200 is similar to IHS 100 of FIG. 1 with like numerals indicating like elements. However, in IHS 200 of FIG. 2, PMC 166 generates 2 different thresholds, namely IREF1 for comparator 175 which is associated with adapter 165 and another threshold IREF2 for comparator 180 which is associated with battery 170. When a particular adapter 165 is plugged into IHS 200, PMC 166 consults a look-up table in nonvolatile memory 167 and provides an appropriate reference current threshold IREF1 to comparator 175 according to the power rating of the particular adapter 165. The higher the power rating of the particular adapter 165, the higher IREF1 can be.

When a particular battery 170 is plugged into IHS 200, PMC 166 consults the look-up table in nonvolatile memory 167 and provides an appropriate reference threshold IREF2 to comparator 180 according to the power rating of the particular battery 170. The higher the power rating of the particular battery 170, the higher IREF2 can be. In this embodiment, IREF1 and IREF2 are dynamically generated depending on the particular AC adapter 165 and particular battery 170 plugged in to IHS 200. Moreover, IREF1 and IREF2 can have different values.

In another embodiment, AC adapter current IA is compared to IREF1 without comparing battery output current IB against IREF2. This comparison is then used in making the decision of when to assert PROC_HOT# to throttle back processor 105. Conversely, in yet another embodiment, battery output current IB is compared against IREF2 without comparing AC adapter current IA against IREF1. This comparison is then used in making the decision of when to assert PROC_HOT# to throttle back processor 105.

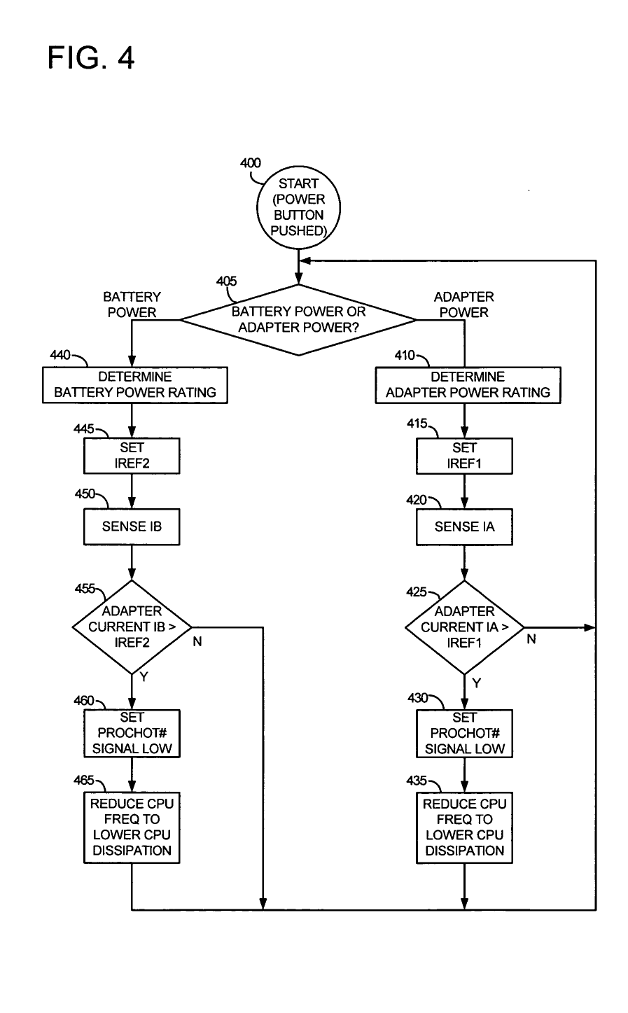

In yet another embodiment, PMC 165 senses when AC adapter 165 is plugged into IHS 200 and AC mains power is present. PMC 165 also senses when battery 170 is plugged into IHS 200. This embodiment is discussed in more detail with reference to the flowchart of FIG. 4. If PMC 165 senses that AC adapter 165 is plugged in and providing power, PMC 166 determines the PS ID of the particular AC adapter to learn the particular adapter's power output rating. PMC 166 then retrieves an appropriate reference current threshold, IREF1, for that particular AC adapter and sets the inverting input (−) of comparator 175 to IREF1. In this case, IREF1 will dynamically vary according to the power rating of the particular AC adapter 165 that is plugged into IHS 200. If PMC 165 senses that battery 170 is plugged into IHS 200 and that AC adapter 165 is not plugged in to provide power, then PMC 166 determines the BATT ID of the particular battery 170 to learn the particular battery's power output rating. PMC 166 then retrieves an appropriate reference current threshold, IREF2, for that particular battery and sets the inverting input (−) of comparator 180 to IREF2. In this case, IREF2 will dynamically vary according to the power rating of the particular battery 170 that is plugged into IHS 200.

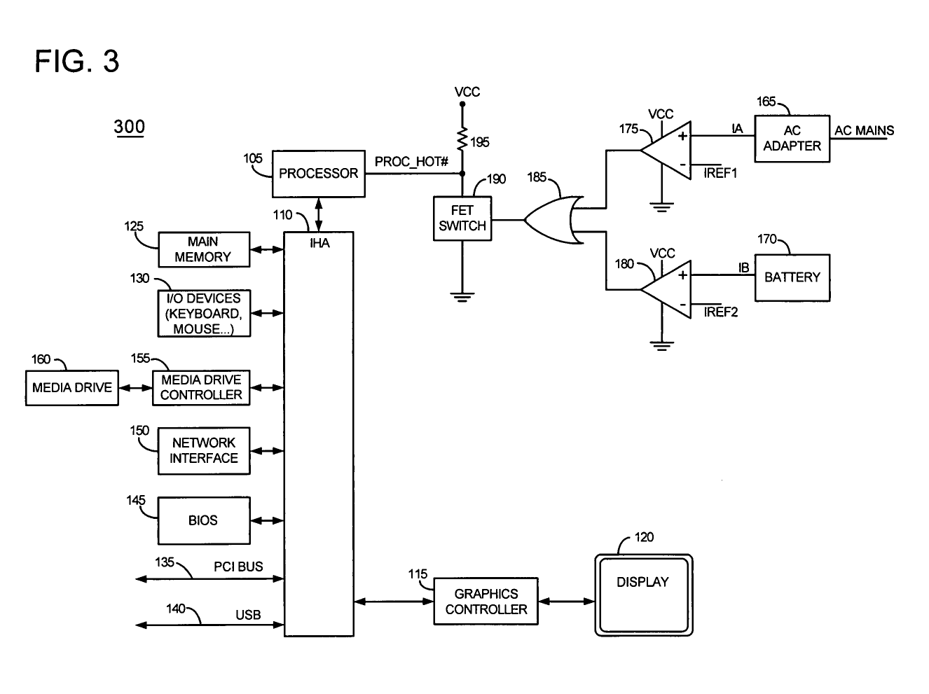

FIG. 3 shows a block diagram of another embodiment of the information handling system as IHS 300. IHS 300 is similar to IHS 200 of FIG. 2 with like numerals indicating like elements. However, in IHS 300 of FIG. 3, reference current thresholds IREF1 and IREF2 are hard wired. In other words, the inverting input of comparator 175, associated with AC adapter 165, is coupled to a reference current IREF1 source. The inverting input of comparator 180, associated with battery 170, is coupled to a reference current IREF2 source. Here the reference current thresholds are fixed. It is noted that In actual practice, since comparators compare voltages, the current values applied to the inputs of the comparators are represented in terms of voltages.

In another embodiment, AC adapter current IA is compared to IREF1 without comparing battery output current IB against IREF2. Conversely, in yet another embodiment, battery output current IB is compared against IREF2 without comparing AC adapter current IA against IREF1.

FIG. 4 is a flowchart which shows process flow in IHS 200 of FIG. 2. Process flow commences at block 400 at which the user presses the power on button (not shown) of IHS 200. IHS 200 then senses whether it is being powered by AC adaptor power or battery power as per decision block 405. If IHS 200 finds that it is being powered by AC adaptor power at decision block 405, then PMC 166 determines the power rating of the particular AC adapter as per block 410. PMC 166 then sets an appropriate reference current threshold IREF1 as per block 415. IHS 200 then senses the present AC adapter output current IA as per block 420. A test is then conducted by comparator 175 to see if the present AC adapter output current IA exceeds the threshold IREF1 as per decision block 425. If the IREF1 threshold is not exceeded then flow continues back to decision block 405. However, if at some point in time the adapter output current IA does exceed the IREF1 threshold, then flow continues from decision block 425 to block 430 at which the PROCHOT# terminal is set to low. This causes processor 105 to reduce its operating frequency as per block 435 and results in lowering the power draw on the AC adapter.

At decision block 405 it is possible that IHS 200 is presently being powered by battery 170 and not AC adapter 165. In this event, process flow continues to block 440 at which PMC 166 determines the power rating of the particular battery which is plugged into IHS 200. PMC 166 then sets an appropriate reference current threshold IREF2 as per block 445. IHS 200 then senses the present battery output current IB as per block 450. A test is then conducted by comparator 180 to see if the battery output current IB exceeds the threshold IREF2 as per decision block 455. If the IREF2 threshold is not exceeded then flow continues back to decision block 405. However, if at some point in time the battery output current IB does exceed the IREF2 threshold, then flow continues from decision block 455 to block 460 at which the PROCHOT# terminal is set to low. This causes processor 105 to reduce its operating frequency as per block 465 and results in lowering the power draw on the AC adapter.

Advantageously, the disclosed methodology and apparatus provide a way to quickly throttle back power consumption of an IHS when a rapid fluctuation in power adapter output current or battery output current is detected.

Although illustrative embodiments have been shown and described, a wide range of modification, change and substitution is contemplated in the foregoing disclosure and in some instances, some features of an embodiment may be employed without a corresponding use of other features. Accordingly, it is appropriate that the appended claims be construed broadly and in manner consistent with the scope of the embodiments disclosed herein.

1. A method of operating an information handling system (IHS) including a processor, the method comprising:
determining if a power adapter or a battery is supplying power to the IHS;
continuously monitoring the output current of the power adapter if the power adapter is supplying power to the IHS;
continuously monitoring the output current of the battery if the battery is supplying power to the IHS;
reducing the frequency at which the processor operates if the power output of the power adapter exceeds a first threshold current level; and
reducing the frequency at which the processor operates if the power output of the battery exceeds a second threshold current level.

2. The method of claim 1 wherein the first and second threshold current levels are the same.

3. The method of claim 1 wherein the first and second threshold current levels are different.

4. The method of claim 1 including determining the power output rating of the power adapter if the power adapter is supplying power to the IHS.

5. The method of claim 4 including setting the first threshold current level dependent on the power output rating of the power adapter.

6. The method of claim 1 including determining the power output rating of the battery if the battery is supplying power to the IHS.

7. The method of claim 6 including setting the second current threshold level dependent on the power output rating of the battery.

8. A method of operating an information handling system (IHS) including a processor, the method comprising:
determining if a power adapter or a battery is supplying power to the IHS;
continuously monitoring the output current of the power adapter if the power adapter is supplying power to the IHS;
continuously monitoring the output current of the battery if the battery is supplying power to the IHS; and
reducing the frequency at which the processor operates if the power output of the power adapter exceeds a predetermined threshold current level or the power output of the battery exceeds the predetermined threshold current level.

9. The method of claim 8 including determining the power output rating of the power adapter and the power output rating of the battery.

10. The method of claim 9 including setting the predetermined threshold current level dependent on the power output rating of the power adapter and the power output rating of the battery.

11. A method of operating an information handling system (IHS) including a processor, the method comprising:
continuously monitoring the output current of a power adapter which supplies power to the IHS; and
reducing the frequency at which the processor operates if the power output of the power adapter exceeds a first threshold current level.

12. A method of operating an information handling system (IHS) including a processor, the method comprising:
continuously monitoring the output current of a battery which supplies power to the IHS; and
reducing the frequency at which the processor operates if the power output of the power battery exceeds a first threshold current level.

13. An information handling system (IHS) comprising
a processor;
a memory coupled to the processor;
an AC adapter and a battery for supplying power to the IHS; and
a power control circuit, coupled to the AC adapter and the battery, for reducing the frequency at which the processor operates if the power output of either the AC adapter or the battery instantaneously exceeds a predetermined threshold level, the predetermined threshold level being dependent on the power output rating of the AC adapter and the power rating of the battery.

14. The IHS of claim 13 wherein the power control circuit monitors a power supply identification signal from the AC adapter to determine the power rating of the AC adapter.

15. The IHS of claim 13 wherein the power control circuit monitors a battery identification signal from the battery to determine the power rating of the battery.

16. The IHS of claim 13 wherein the processor includes a control pin for controlling the frequency at which the processor operates.

17. An information handling system (IHS) comprising
a processor;
a memory coupled to the processor;
an AC adapter for supplying power to the IHS; and
a power control circuit, coupled to the AC adapter, for reducing the frequency at which the processor operates if the power output of the AC adapter instantaneously exceeds a predetermined threshold level, the predetermined threshold level being dependent on the power output rating of the AC adapter.

18. The IHS of claim 17 wherein the power control circuit monitors a power supply identification signal from the AC adapter to determine the power rating of the AC adapter.

19. The IHS of claim 17 wherein the processor includes a control pin for controlling the frequency at which the processor operates.

20. An information handling system (IHS) comprising:
a processor;
a memory coupled to the processor;
a battery for supplying power to the IHS; and
a power control circuit, coupled to the battery, for reducing the frequency at which the processor operates if the power output of the battery instantaneously exceeds a predetermined threshold level, the predetermined threshold level being dependent on the power output rating of the battery.

21. The IHS of claim 20 wherein the power control circuit monitors a battery identification signal from the battery to determine the power rating of the battery.

22. The IHS of claim 20 wherein the processor includes a control pin for controlling the frequency at which the processor operates.

23. A system for operating an information handling system (IHS) including a processor, the system comprising:
means for determining if a power adapter or a battery is supplying power to the IHS;
means for continuously monitoring the output current of the power adapter if the power adapter is supplying power to the IHS;
means for continuously monitoring the output current of the battery if the battery is supplying power to the IHS;
means for reducing the frequency at which the processor operates if the power output of the power adapter exceeds a first threshold current level; and
means for reducing the frequency at which the processor operates if the power output of the battery exceeds a second threshold current level.
